(19) United States
(12) Patent Application Publication
(10) Pub. No.: US 2014/0269847 A1
(43) Pub. Date: Sep. 18, 2014

(54) SYMBOL-LEVEL EQUALIZATION USING MULTIPLE SPREADING FACTORS

(71) Applicant: BROADCOM CORPORATION, Irvine, CA (US)

(72) Inventor: Fu-Hsuan Chiu, Berkeley Heights, NJ (US)

(73) Assignee: Broadcom Corporation, Irvine, CA (US)

(21) Appl. No.: 13/854,432

(22) Filed: Apr. 1, 2013

Related U.S. Application Data
(60) Provisional application No. 61/798,918, filed on Mar. 15, 2013.

(51) Int. Cl. H04B 1/7103

(52) U.S. Cl. CPC H04B 1/7103
USPC 375/148

(57) ABSTRACT

Techniques are described herein that perform symbol-level equalization using multiple spreading factors. The techniques may allow for symbol-level equalization to be performed between a serving cell and a non-serving cell(s) for WCDMA and HSDPA protocols, for example. A serving cell operates using a first spreading factor, and a non-serving cell(s) operates using a second, different spreading factor. Data communications received from the serving cell and the non-serving cell(s) may be aligned using extended channel representation(s) of the non-serving cell(s) and/or scrambling code offset(s). The aligned communications may be equalized using symbol-level equalization to obtain a joint linear minimum mean square error between the serving cell and the non-serving cell(s).

### CROSS-REFERENCE TO RELATED APPLICATION(S)

This application claims the benefit of U.S. Provisional Application No. 61/798,918, filed Mar. 15, 2013, the entirety of which is incorporated by reference herein.

### BACKGROUND

1. Technical Field

The subject matter described herein relates to communication systems, communication devices and methods for performing symbol-level equalization using multiple spreading factors.

2. Background Art

Communication systems (e.g., telecommunication systems) may operate in accordance with any of a variety of communication protocols. For example, communications over channels between “cells” and communication devices such as cellular phones and smart phones may be performed using a Wideband Code Division Multiple Access (WCDMA) protocol or a High-Speed Downlink Packet Access (HSDPA) protocol. A cell is a device or system that is configured to transmit signals to communication devices (e.g., mobile communication devices).

Examples of a cell include but are not limited to a base station, a radio network controller, etc. A cell may be a serving cell or a non-serving cell with regard to a communication device. A serving cell is a cell that engages in two-way communication with the communication device. For instance, a serving cell may transmit signals that are received by the communication device, and the communication device may transmit signals back to the serving cell in response. A non-serving cell is a cell that engages in one-way communication with the communication device. For instance, a non-serving cell may transmit signals that are received by the communication device, but the communication device does not transmit signals back to the non-serving cell in response. A non-serving cell may be an interfering cell or non-interfering cell with regard to a communication device. An interfering cell (a.k.a. “interference cell”) is a non-serving cell whose transmissions that are received by the communication device interfere with processing of signal(s) that are received from serving cell(s) by the communication device. For instance, the communication device may suppress transmissions from an interfering cell to accurately decode signals that are received from a serving cell. A non-interfering cell is a non-serving cell whose transmissions that are received by the communication device do not interfere with processing of signal(s) that are received from serving cell(s) by the communication device. For instance, the communication device may accurately decode signals that are received from a serving cell without suppressing transmissions from an interfering cell.

A cell may be synchronous or asynchronous with regard to a communication device. A synchronous cell is a cell that is synchronized with the communication device. An asynchronous cell is a cell that is not synchronized with the communication device. A cell that constitutes a serving cell with regard to a communication is synchronized with the communication device. Whereas, a cell that constitutes a non-serving cell with regard to a communication device may be synchronized with the communication device or not synchronized with the communication device.

A communication device may receive communications from serving cell(s) and/or non-serving cell(s) independently or in a substantially concurrent manner. Such a communication device typically equalizes the received communications with symbol-level equalization or chip-level equalization. Although symbol-level equalization often provides better performance, as compared to chip-level equalization, for serving cells, conventional symbol-level approaches often suffer from system modeling errors associated with non-serving cells that are interfering cells and/or asynchronous cells. The modeling errors for these non-serving cells may make joint symbol-level equalization between serving cells and non-serving cells complex, difficult, and/or inaccurate. For example, maintaining a minimum mean square error (MMSE) for serving cells and for non-serving cells that are interfering cells and/or asynchronous cells (i.e., a joint MMSE) has not been accomplished in the art using symbol-level equalization due to data misalignments and variable channel conditions. Conventional communication devices have decomposed the joint MMSE problem (equalizing serving cells and non-serving cells jointly) to be a per-cell MMSE problem (equalizing serving cells and non-serving cells separately), which suffers from inefficiencies and performance loss.

### BRIEF SUMMARY

Methods, systems, and apparatuses are described for performing symbol-level equalization using multiple spreading factors, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form part of the specification, illustrate embodiments of the disclosed technologies and, together with the description, further serve to explain the principles involved and to enable a person skilled in the relevant art(s) to make and use the disclosed technologies.

FIG. 1 is a block diagram of a communication system, according to an exemplary embodiment.

FIG. 2 is a block diagram of an example implementation of a portion of a communication device shown in FIG. 1, according to an exemplary embodiment.

FIG. 3 is a block diagram of an example implementation of a portion of a receiver shown in FIG. 2, according to another exemplary embodiment.

FIG. 4 is a diagram of data alignment between a serving cell and a non-serving cell.

FIG. 5 is a diagram of data alignment between a serving cell and a non-serving cell using multiple spreading factors, according to an exemplary embodiment.

FIGS. 6 and 7 are flowcharts of example methods for performing equalization of data communications using multiple spreading factors, according to exemplary embodiments.

FIG. 8 is a block diagram of a computer system in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### 1. Introduction

The following detailed description refers to the accompanying drawings that illustrate example embodiments of the disclosed technologies. However, the scope of the disclosed technologies is not limited to these embodiments, but is instead defined by the appended claims. Thus, embodiments beyond those shown in the accompanying drawings, such as modified versions of the illustrated embodiments, may nevertheless be encompassed by the disclosed technologies.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Further, descriptive terms used herein such as “about,” “approximately,” and “substantially” have equivalent meanings and may be used interchangeably.

Still further, as discussed herein, matrices have dimensions denoted in the format of “row×column” (i.e., row by column) For example, the matrix A=[1 0 1] has 1 row and 3 columns, thus a size or dimension of 1×3.

Still further, references to matrices (e.g., a matrix denoted as ‘x’) and to vectors (e.g., a vector denoted as ‘ x̅’ are considered interchangeable, and reference to either notation may be used in certain contexts herein for illustrative and/or explanatory purposes. For example, matrix ‘x’ may be a vector, and likewise vector ‘ x̅’ may be a matrix. In embodiments, matrix ‘x’ may be vector ‘ x̅’.

Still further, the term “data communications” refers to information transmitted from a cell to a communication device and/or a receiver. As used herein, “data communications” may refer to communications such as voice communications (e.g., Voice over Internet Protocol, voice-only, etc.), data communications, control communications, and/or the like. The term “sampled data communications” refers to sampled representations of received “data communications.” As such, the term “data communications” may be used in place of “sampled data communications” without departing from the meaning thereof.

Numerous exemplary embodiments are described as follows. It is noted that any section/subsection headings provided herein are not intended to be limiting. Embodiments are described throughout this document, and any type of embodiment may be included under any section/subsection. Furthermore, disclosed embodiments may be combined with each other in any manner

### 2. Example Embodiments

The examples described herein may be adapted to various types of wired and wireless communications systems (e.g., telecommunication systems, computing systems, communication devices, components thereof and/or the like, which include receivers and equalizers such as symbol-level equalizers). Furthermore, additional structural and operational embodiments, including modifications/alterations, will become apparent to persons skilled in the relevant art(s) from the teachings herein.

Various approaches are described herein for, among other things, receiving and equalizing (e.g., via symbol-level equalization) data communications having multiple spreading factors that are transmitted to a receiver system/architecture. In embodiments, communication systems may be based on the WCDMA and/or HSDPA standards for wireless data communications.

The receiver system/architecture may be included in a communication device (e.g., a mobile device, such as a personal digital assistant (PDA), a cellular telephone, a smart phone, a tablet computer, a laptop computer, etc.). The receiver system/architecture may include programmable modules or blocks (e.g., circuit modules/blocks, software modules/blocks, firmware modules/blocks, or any combination thereof) that are programmable to perform equalization on data communications transmitted to a receiver system/architecture in the communication system using multiple spreading factors. The receiver system/architecture may receive data communications from one or more cells (e.g., base station transceivers, radio network controllers, and/or the like) according to one or more spreading factors, using one or more antennas. In embodiments, a serving cell that provides data communications to a communication device may operate using a first spreading factor, and a non-serving cell may operate using a second, different spreading factor. For example, the serving cell may operate using a spreading factor of 256 (operation in a spreading factor 256 domain), while the non-serving cell may operate using a spreading factor of 16 (operation in a spreading factor 16 domain). The received data communications from the serving and non-serving cells may be processed and equalized (e.g., via symbol-level equalization) by the various blocks of receiver system/architecture or a subset thereof to produce an equalized output signal, for example, which may be processed by other components of the communication device.

Symbol-level equalization may be performed in any of a variety of ways. In embodiments, performing symbol-level equalization maintains a minimum mean square error (MMSE) for both serving cells and non-serving cells (including, e.g., asynchronous cells, interfering cells, and/or the like) thus substantially improving system performance. In other words, a joint MMSE may be maintained. In the context of the description herein, embodiments may use the Krylov Method Based Symbol Level Equalization (“SyLK EQ”) approach, though the example embodiments are not limited in this respect. It will be recognized that other approaches are contemplated as would be understood by a person of skill in the relevant art(s) having the benefit of this disclosure. Generally, equalization is performed to solve a linear MMSE equation with variables representing parameters of a given data communication. For instance, in embodiments described herein, a symbol-level equalizer may solve the following linear equation for x̅:

$$\underbrace{( {Λ}^{- 1} + {C}^{H} {S}^{H} {H}^{H} HSC )}_{A} \overline{x} = \underbrace{{C}^{H} {S}^{H} {H}^{H} \overline{y}}_{b} , \qquad ( 1 )$$

where y̅ is complex input data (e.g., received chips) to be equalized, H is a complex channel vector, Λ is a signal-to-noise vector, C is a spreading code vector, and S is a scrambling code vector. The superscript “H” (‘^{H}’) denotes channel effects on given parameters. The result x̅ is the set of equalized chips. Further details of symbol-level equalization according to embodiments are discussed below in section 6 of this document, entitled “Example Symbol-Level Equalization Embodiments.”

Embodiments presented herein improve communication signal equalization, e.g., symbol-level equalization, by transmitting at a first spreading factor from a serving cell and at a second, different spreading factor from non-serving cell(s). Transmitted signals are received and symbol-level equalization is performed on the data communications received from both the serving cell and the non-serving cell(s).

For instance, methods, systems, and apparatuses are provided for performing symbol-level equalization for serving-cells and non-serving cells. In an example aspect, a method is disclosed. The method includes receiving first data communications from a serving cell that operates using a first spreading factor. The method also includes receiving second data communications from at least one non-serving cell that operates using a second spreading factor that is different from the first spreading factor. The method further includes performing symbol-level equalization on a plurality of data communications that includes the first data communications and the second data communications.

In another example aspect, a mobile communication device is disclosed that includes a receiver block, an adjustment block, and an equalizer block. The receiver block is configured to receive first data communications from a serving cell that operates using a first spreading factor and second data communications from at least one non-serving cell that operates using a second spreading factor that is different from the first spreading factor. The adjustment block is configured to align the first data communications and second data communications with respect to time. The equalizer block is configured to perform symbol-level equalization on the aligned first and second data communications.

In yet another example aspect, a computer-readable storage medium having computer program instructions recorded thereon that, when executed, enable a processor-based system to perform a method is disclosed. The method includes receiving first data communications from a serving cell that operates using a first spreading factor. The method also includes receiving second data communications from at least one non-serving cell that operates using a second spreading factor that is different from the first spreading factor. The method further includes performing symbol-level equalization on a plurality of data communications that includes the first data communications and the second data communications.

Various example embodiments are described in the following subsections. In particular, example communication system embodiments are described, followed by example receiver architecture embodiments. Next, example embodiments for data alignment using multiple spreading factors are described. Equalization embodiments using different spreading factors for serving and non-serving cells are subsequently described followed by further example embodiments and advantages. Next, example operational embodiments are described. Finally, an example computer-implemented embodiment is described.

### 3. Example Communication System Embodiments

Communication systems may be configured in various ways, according to embodiments. As described above, a receiver system/architecture (e.g., in a communication device) may receive data communications from one or more cells according to one or more spreading factors. Each cell may be a serving cell or a non-serving cell with regard to the communication device. Each non-serving cell may be an asynchronous cell with regard to the communication device and/or an interfering cell with regard to the communication device. A serving cell operates in a synchronous manner, in embodiments, and transmits signals and data to communication devices along known reference points or boundaries common to both the serving cell and the communication devices. In contrast, cells operating in an asynchronous manner are not constrained in this manner. In embodiments, any one or more non-serving cells may be an interfering cell with regard to any one or more of the communication devices. A receiver system/architecture may monitor the radio frequency signals that are received from such interfering cell(s) and suppress interference (e.g., by monitoring the covariance of the interfering cell(s) with respect to the serving cell) in order to decode the radio frequency signals that are received from the serving cell in an accurate manner. The covariance portion of the radio frequency signals received from an interfering cell may be monitored and not fully processed (e.g., not fully decoded).

Turning to FIG. 1, an exemplary communication system is depicted, according to an embodiment. FIG. 1 shows a communication system 100 that includes multiple cells. As shown, communication system 100 includes a serving cell 102 and non-serving cells 104, 106, 108, 110, 112, and 114. A communication device 116 is shown as currently residing in serving cell 102. Serving cell 102 includes a transmitting device 118 such as a base station, a radio network controller and/or the like. Non-serving cell 104 includes a transmitting device 120 which may also be a base station, a radio network controller and/or the like. Transmitting devices 118 and 120 communicate with communication device 116 over communication channels 122 and 124, respectively.

As depicted in FIG. 1, serving cell 102 transmits data communications to communication device 116 using transmitting device 118, and communication device 116 receives and equalizes the signals. Non-serving cell 104 also transmits data communications to communication device 116 using transmitting device 120. As shown, non-serving cell 104 may be an interfering cell and/or an asynchronous cell in embodiments. Communication device 116 also receives and equalizes the signals from non-serving cell 104, but may ignore the covariance portions of the received signals. Communication device 116 may jointly equalize the received signals from both serving cell 102 and non-serving cell 104. That is, in embodiments, this equalization is a joint equalization that maintains a joint MMSE. Further, in embodiments, symbol-level equalization may be performed on the data communications received from both serving cell 102 and non-serving cell 104. Due to channel effects and data misalignments between transmissions from serving cell 102 and non-serving cell 104 (e.g., serving cell 102 is synchronous and non-serving cell 104 is asynchronous and/or interfering), joint symbol-level equalization may be accomplished by aligning the misaligned data prior to performing equalization according to the embodiments described herein.

It is contemplated that, while not shown for sake of clarity, each other non-serving cell depicted in FIG. 1 may be configured in a manner similar to non-serving cell 104 as described above, and that multiple non-serving cells may simultaneously communicate with communication device 116.

Communication system 100 and each of the elements included therein may be implemented in hardware, or a combination of hardware and software and/or firmware.

Communication system 100 and each of the components included therein may include functionality and connectivity beyond what is shown in FIG. 1, as would be apparent to persons skilled in relevant art(s). However, such additional functionality is not shown in FIG. 1 for the sake of brevity.

The next section describes example receiver architecture embodiments in the context of communication device 116 as described above and shown in FIG. 1. However, the receiver architectures that will be described are not intended to be limiting.

### 4. Example Receiver Architecture Embodiments

A receiver in a communication device and/or in a communication system may have an architecture configured in various ways to equalize received data communications using multiple spreading factors using an equalizer or equalizer block, in embodiments. The receiver may perform symbol-level equalization using a symbol-level equalizer on the data communications having different spreading factors. In embodiments described herein, pre-processing may be performed on data communications having different spreading factors that are received at a communication device and/or a receiver to enable the equalization of the data communications.

For example, FIG. 2 shows a block diagram of a portion of a communication device 200, according to an embodiment. Communication device 200 may be a further embodiment of communication device 116 of FIG. 1. Communication device 200 includes a receiver 202 and an antenna 204. Antenna 204 is communicatively coupled to receiver 202 via line 206. Receiver 202 includes a receiver block 208, an adjustment block 212, and an equalizer block 216. Receiver block 208 and adjustment block 212 are connected via a line 210, receiver block 208 and equalizer block 216 are connected via line 210, and adjustment block 212 and an equalizer block 216 are connected via line 214.

Antenna 204 may be configured to receive data communications over channels such as a communication channel in a telecommunication system (e.g., communication channel 122 and/or communication channel 124 of FIG. 1). The data communications may be received from serving cells (e.g., serving cell 102 of FIG. 1) or from non-serving cells (e.g., non-serving cell 104 of FIG. 1). In embodiments, data communications may be received from a serving cell that operates using a first spreading factor (e.g., a 256-code spreading factor), and data communications may be received from a non-serving cell a that operates using a second spreading factor that is different from the first spreading factor (e.g., a 16-code spreading factor).

It is contemplated that, in some embodiments, antenna 204 may comprise one or more individual antennas as would be understood by a person of skill in the relevant arts having the benefit of this disclosure.

Receiver block 208 takes data communications received by antenna 204 as inputs via line 206. Receiver block 208 prepares the data communications for equalization (e.g., symbol-level equalization) as described herein. For instance, the data communications may be sampled, filtered, and buffered before equalization. Additionally, channel processing and channel estimation may be performed before equalization. Receiver block 208 may also perform specific functions and processes common to receivers as would be apparent to one of skill in the relevant art(s) having the benefit of this disclosure. Exemplary functions and processes are described in further detail herein with respect to FIG. 3 below.

Adjustment block 212 receives data from receiver block 208. For instance, adjustment block 212, as shown, receives channel information, e.g., channel estimation information, from receiver block 208. In embodiments, adjustment block 212 generates and inserts scrambling code offsets into data communications that are received from receiver block 208 and generates extended channel representations associated with the communication channels described above. In this manner, adjustment block 212 “preprocesses” portions of the received data communications for use by equalizer block 216, as discussed in further detail herein. While shown as a separate block for illustrative purposes, it will be recognized that adjustment block 212 may be implemented within equalizer block 216.

Equalizer block 216 takes inputs from receiver block 208 and from adjustment block 212. Generally, equalizer block 216 performs equalization using the received inputs, e.g., received, sampled data communications. In embodiments, equalizer block 216 performs symbol-level equalization of data communications transmitted using multiple spreading factors and received at receiver 202. For instance, sampled data communications (e.g., of complex data received over a communication channel from serving and/or non-serving cells) may be equalized using symbol-level equalization techniques described herein. In embodiments, the sampled data communications are inputs from receiver block 208. Equalizer block 216 may receive preprocessed representations of channel estimations and scrambling code offsets from adjustment block 212 to be used during the symbol-level equalization of data communications transmitted using multiple spreading factors.

Communication device 200 and each of the elements included therein may be implemented in hardware, or a combination of hardware and software and/or firmware.

Communication device 200 and each of the components included therein may include functionality and connectivity beyond what is shown in FIG. 2, as would be apparent to persons skilled in relevant art(s) having the benefit of this disclosure. However, such additional functionality is not shown in FIG. 2 for the sake of brevity.

Exemplary receiver embodiments will now be described in further detail.

Turning now to FIG. 3, a block diagram of an exemplary receiver (“receiver”) 300 is depicted, according to embodiments. Receiver 300 may be a further embodiment of receiver 202 shown in FIG. 2. For instance, the exemplary receiver architecture/configuration of receiver 300 shown in FIG. 3 is adapted to perform symbol-level equalization of data communications transmitted using multiple spreading factors and received at receiver 300.

As shown, receiver 300 includes a baseband radio frequency sampler (BBRF) 302, a decimator 306, a memory buffer 310, a common pilot channel processing block (CPICH) 312, a delay locked loop (DLL) 316, a channel estimation block (ChEst) 322, an adjustment block 326, and an equalizer (EQ) 332. BBRF 302 provides its output to decimator 306 via a line 304. Decimator 306 provides its output to memory buffer 310 and to CPICH 312 via a line 308. CPICH 312 provides an output to DLL 316 via a line 314, and DLL 316 provides its output to decimator 306 via a line 318. Another output of CPICH 312 is provided to ChEst 322. ChEst 322 provides its output to adjustment block 326 via a line 324. Adjustment block 326 provides its output to EQ 332 via a line 328, and memory buffer 310 provides its output to EQ 332 via a line 330. The output of EQ 332 is provided to other blocks and/or modules of receiver 300 (not shown) via a line 334, and may also be provided as an output of receiver 300 (e.g., the output of EQ 332 may be provided to components of a communication device 200, as shown in FIG. 2).

In embodiments, BBRF 302, decimator 306, memory buffer 310, CPICH 312, DLL 316, and ChEst 322 may comprise a further embodiment of receiver block 208, as shown in FIG. 2. In embodiments, adjustment block 326 may be a further embodiment of adjustment block 212, as shown in FIG. 2. In embodiments, EQ 322 may be a further embodiment of equalizer block 216, as shown in FIG. 2. Further, while shown as a separate block for illustrative purposes, adjustment block 326 may, in practice and/or in various embodiments, be implemented within EQ 332.

It should be noted that the connections between components shown in FIG. 3 are not limiting and are not intended to be exhaustive. Other connections between components may be present as would become apparent to persons skilled in relevant art(s) having the benefit of this disclosure, but such connections are not shown for the sake of brevity and for clarity of illustration.

The components of receiver 300 are now described in further detail. For instance, BBRF 302 receives data communications from one or more antennas (e.g., antenna 204 of FIG. 2). BBRF 302 performs a sampling of the received data communications to generate one or more data communication samples and/or one or more sampled representations of the data communications. The samples and/or sampled representations (which are considered as data herein) are passed to decimator 306.

Decimator 306 is configured to perform filtering and/or down-sampling of the samples and/or sampled representations generated by BBRF 302. In embodiments, filtering (e.g., low-pass filtering) and down-sampling may be performed to reduce the effective data rate and/or size/bandwidth of the received data communications. Decimated data is passed to memory buffer 310 and to CPICH 312.

Memory buffer 310 is configured to buffer sampled data that is to be provided to EQ 332. Memory buffer 310 may be any suitable configuration of memory such as a first-in, first-out (FIFO) memory, a static random access memory (SRAM), a dynamic random access memory (DRAM), a cache structure, a virtual memory block, and/or the like.

CPICH 312 is configured to perform common pilot channel processing of the sampled data communications, according to embodiments. For instance, CPICH 312 may perform processing to identify common pilot channel patterns and scrambling codes associated with a given transmitting cell.

DLL 316 is configured to adjust a phase of a scrambling code within a signal, according to embodiments. In some embodiments, DLL 316 may reduce timing drift (i.e., sampling phase) associated with sampled representations of received baseband signals.

ChEst 322 is configured to perform estimations and determinations of parameters associated with communication channels of serving and/or non-serving cells. For instance, ChEst 322 may perform processing to calculate channel vectors (e.g., complex channel vectors/matrices) associated with serving and/or non-serving cells. ChEst 322 may also perform processing to estimate common pilot channel power for transmissions from serving and/or non-serving cells.

Adjustment block 326 may be configured to perform estimations and determinations of signal-to-noise (SNR) vectors, spreading code vectors (orthogonal variable spreading factor (OVSF) codes), scrambling code vectors, and/or mask vectors. For instance, adjustment block 326 may determine signal-to-noise ratios (SNRs) of sampled data communications. For example, SNRs may be determined between the power of the data to be equalized by EQ 322 and either common pilot channel power or the power of noise associated with a given channel. Adjustment block 326 may also be configured to perform adjustments of parameters associated with equalization of sampled data communications received from serving and non-serving cells. For instance, channel parameters, noise parameters, data code parameters, scrambling code parameters, spreading code parameters, channel noise parameters and/or the like may be adjusted or modified to allow for symbol-level equalization to performed jointly on serving and non-serving cell data communications. For example, scrambling code offsets and extended channel representations may be implemented/generated by adjustment block 326.

EQ 332 is configured to perform data equalization of sampled data communications received from serving and non-serving cells. In embodiments, EQ 332 performs symbol-level equalization of sampled data communications received from serving and non-serving cells. Symbol-level equalization may utilize parameters adjusted by adjustment block 326, according to embodiments.

Receiver 300 and each of the elements included therein may be implemented in hardware, or a combination of hardware and software and/or firmware.

Receiver 300 and each of the components included therein may include functionality and connectivity beyond what is shown in FIG. 3, as would be apparent to persons skilled in relevant art(s). However, such additional functionality is not shown in FIG. 3 for the sake of brevity.

The next section describes example data alignment embodiments in the context of communication device 200 as described above and as shown in FIG. 3, and in the context of receiver 300 as described above and as shown in FIG. 3. However, the example data alignment techniques that will be described are not intended to be limiting.

### 5. Example Data Alignment Embodiments

As noted in the above-described embodiment of receiver 300, a receiver may be configured to perform symbol-level equalization for serving and non-serving cells. For example, a data alignment embodiment using a receiver (e.g., receiver 300) is described in this section. Referring back to FIG. 3, an exemplary block diagram of a portion of receiver 300 that is configured to perform symbol-level equalization (e.g., by equalizer block 332) for serving and non-serving cells and that includes an adjustment block (adjustment block 326) is described. In embodiments, adjustment block 326 is configured to perform the exemplary data alignment techniques described herein.

A communication device (e.g., communication device 200 of FIG. 2) and/or a receiver (e.g., receiver 300 of FIG. 3) are not required to fully decode data communications that are received from an interfering cell. Rather, equalization of the received interfering cell transmission is sufficient to allow the communication device/receiver to obtain information about the interfering cell. Thus, the operating spreading factor of an interfering cell may differ from the operating spreading factor of a serving cell as correlation with respect to the interfering cell is unnecessary.

As noted above, existing solutions are not capable of fully (and correctly or adequately) equalizing serving cells and non-serving cells (e.g., interfering cells or asynchronous cells) using symbol-level equalization. This deficiency is illustrated in FIG. 4, in which a diagram of a data alignment 400 using a serving cell model in a spreading factor 256 (“SF256”) domain and an interfering cell model in the SF256 domain is depicted. That is, each symbol transmitted by the interfering cell is 256 chips in length. As shown in FIG. 4, a symbol received from a serving cell is temporally juxtaposed with symbols received from a non-serving, interfering cell to show symbol misalignment. Specifically, data alignment 400 includes a serving cell symbol 402 (denoted as serving cell symbol K), and two interfering cell symbols: interfering cell symbol 404 (denoted as interfering cell symbol K) and interfering cell symbol 406 (denoted as interfering cell symbol K−1). The notation of the depicted symbols (i.e., K−1 and K) are for illustrative purposes to show misalignments of corresponding symbols between serving and interfering cells (e.g., serving cell symbol 402 “K” and interfering cell symbol 404 “K”).

For instance, as shown, serving cell symbol 402 is misaligned with interfering cell symbol 404 by a misalignment value 408, and serving cell symbol 402 is misaligned with interfering cell symbol 406 by a misalignment value 410. Due to the operation of the interfering cell at SF256, the misalignment may be as much as half of the symbol length (i.e., 128 chips) and may be referred to as leading or lagging with respect to either a serving cell symbol or an interfering cell symbol. Such misalignment may arise from an interfering, non-serving cell being asynchronous with respect to a serving cell and a communication device. Due to varying channel effects and noise levels, the interfering cell symbols 404 and 406 cannot simply be phase adjusted to compensate for the misalignment. That is, the condition of the channel is not guaranteed to remain constant during transmissions, and thus a received transmission cannot be phase adjusted at the receiver due to the possibility of inaccurately representing the data communication which would result in improper equalization and decoding of the received transmission. In other words, because different temporal “windows” may have different channel parameters, equalization errors will arise and a joint-MMSE is not maintained.

As previously noted, and in accordance with embodiments described herein, symbol-level equalization may be performed between a serving cell and a non-serving cell when the serving cell operates using a first spreading factor (e.g., in a spreading factor 256 (“SF256”) domain), and the non-serving, interfering cell operates using a second, different spreading factor (e.g., in a spreading factor 16 (“SF16”) domain).

As shown in FIG. 5 and in accordance with embodiments described herein, a diagram of a data alignment 500 using a serving cell model in a SF256 domain and an interfering cell model in a SF16 domain is depicted. Specifically, data alignment 500 includes a serving cell symbol 502 (denoted as serving cell symbol K), and a number of interfering cell symbols 504. Each of the interfering cell symbols 504 has a length of 16 chips per SF16. As shown, serving cell symbol 502 is boundary-misaligned with interfering cell symbols 504 by a misalignment value 506 at the leading edge of serving cell symbol 502 and by a misalignment value 508 at the trailing edge of serving cell symbol 502. Due to the operation of the interfering cell at SF16, the misalignment may only be as much as half of the symbol length (i.e., 8 chips). That is, misalignment value 506 and misalignment value 508 have a maximum value of 8 chips, which is significantly less than the misalignment potential described above with respect to FIG. 4.

A maximum misalignment of 8 chips enables symbol-level equalization to be performed by an equalizer (e.g., EQ 332 of receiver 300 in FIG. 3) on data communications received from a serving cell with data communications received from a non-serving cell, e.g., an interfering cell. For instance, a scrambling code offset and a channel representation effectively obtained by padding a channel matrix with zeroes (‘0’) allows for joint symbol-level equalization to be correctly performed, as will be explained in further detail in the sections below.

Furthermore, SF16 operation of non-serving cells is more efficient over SF256 operation for symbol-level equalization of serving cell data communications with non-serving cell data communications at least because padding a SF256 matrix is exceedingly computationally intensive and relatively inefficient with respect to power, time, and processing considerations.

The next section describes example symbol-level equalization embodiments in the context of receiver 300 as described above and as shown in FIG. 3 and in the context of data alignment 500 as described above and as shown in FIG. 5. However, the symbol-level equalization techniques that will be described are not intended to be limiting.

### 6. Example Symbol-Level Equalization Embodiments

As noted above, to achieve complete and correct symbol-level equalization of signals received from a serving cell and a non-serving cell (e.g., an asynchronous cell and/or an interfering cell) a requisite level of data alignment for data communications received from the serving cell and the non-serving cell is required. In accordance with embodiments described herein, a system configuration with a serving cell operating using a spreading factor of 256 and one or more non-serving cells operating using a spreading factor of 16, such alignment may be obtained. In other words, a receiver/equalizer may compensate for (and overcome) a symbol-to-symbol misalignment of 8 chips or less between the serving and non-serving cells, as described above with respect to FIG. 5, to achieve symbol-level equalization.

As noted in the Introduction section, in accordance with embodiments, a symbol-level equalizer (e.g., EQ 332 of FIG. 3) may solve Equation 1 (reproduced here) for x̅:

$$\underbrace{( {Λ}^{- 1} + {C}^{H} {S}^{H} {H}^{H} HSC )}_{A} \overline{x} = \underbrace{{C}^{H} {S}^{H} {H}^{H} \overline{y}}_{b} , \qquad ( 1 )$$

where y̅ is the complex input data to be equalized, H is the complex channel vector, Λ is the signal-to-noise (SNR) vector, C is the spreading code vector (e.g., OVSF codes), and S is the scrambling code vector. The superscript “H” (‘^{H}’) denotes the channel effect associated with a given vector, and the result x̅ is the set of equalized chips. Thus, x̅=b/A, or more completely:

x̅_{symEQ}=(C^{H}S^{H}H^{H}_{HSC}+Λ⁻¹)⁻¹C^{H}S^{H}H^{H}. (2)

According to the Krylov Method Based Symbol Level Equalization (SyLK EQ) approach, Equation 2 is solved using an iterative conjugate gradient method until a solution is reached.

The parameters of Equations 1 and 2 will now be described in further detail.

A. Linear Equation Parameter Embodiments

In embodiments, the vector H may be a convolution matrix of filtering coefficients h having a size L×1 (i.e., ‘L’ rows by ‘1’ column). In embodiments, vector H may be used in convolution operations with a given vector ‘x’ having dimensions K×1. Thus, vector H has dimensions of (K+L−1)×K where, in embodiments, L=16 and K=256. Vector H may be represented as:

$$H = [ \begin{matrix}{h}_{0} & 0 & 0 & 0 & … & 0 & 0 & 0 \\ {h}_{1} & {h}_{0} & 0 & 0 & … & 0 & 0 & 0 \\ ⋮ & {h}_{1} & {h}_{0} & 0 & … & 0 & 0 & 0 \\ {h}_{14} & ⋮ & {h}_{1} & {h}_{0} & 0 & 0 & 0 & 0 \\ {h}_{15} & {h}_{14} & ⋮ & {h}_{1} & ⋱ & 0 & 0 & 0 \\ 0 & {h}_{15} & {h}_{14} & ⋮ & ⋮ & {h}_{0} & 0 & 0 \\ ⋮ & 0 & {h}_{15} & … & ⋮ & {h}_{1} & {h}_{0} & 0 \\ 0 & 0 & 0 & 0 & … & {h}_{2} & {h}_{1} & {h}_{0}\end{matrix} ] \qquad ( 3 )$$

The output Hx of the convolution filtering operation has dimensions (K+L−1)×1 and may be represented as:

Hx=h [symbol] x=Σk=0^{L-1}h[k]x[n−k], (4)

where it is assumed that x[m] for m<−1 is equal to zero. The correlation transpose operation H* of vector H may thus be represented as:

H*x=h\textcircled{*}x=Σₖ₌₀^{L-1}h*[k]x[n+k], (5)

where it is again assumed that x[m] for m<−1 is equal to zero.

The SNR vector Λ may be determined from the noise associated with the transmission channel. An associated mask vector M, which is a diagonal matrix with values of ‘0’ denoting that corresponding OVSF codes are off and with values of ‘1’ denoting that corresponding OVSF codes are on, may be used to mask or “zero-out” OVSF codes that are off or not being utilized by the transmitting base station (e.g., a serving cell or a non-serving cell).

The vector S may be generated according to an initial scrambling seed value. Binary representations of the scrambling codes may correspond to actual complex scrambling code values (i.e., scrambling code values with real and imaginary components). For a vector ‘s’ of dimensions N×1 of scrambling code values which are generated according to the initial seed value associated with the transmitting channel antenna, vector S is the corresponding diagonal scrambling matrix where the diagonal elements of vector S are the elements of the vector s. Thus, the output ‘y’ of the scrambling operation may be represented as:

y=Sx=s\textcircled{·}x. (6)

The vector C may represent a Walsh-Hadamard matrix of spreading codes, according to embodiments. A Walsh-Hadamard matrix contains codes with zero respective correlation (i.e., orthogonal) and thus allows for no associated interference. Walsh-Hadamard matrices may be constructed to be “full rank” (i.e., complete and having no loss of information) such that the inverse of such matrices may be used to obtain an identity matrix. Because of these properties, a Walsh-Hadamard matrix with smaller dimensions may be stacked to form a matrix with larger dimensions, and in this manner, for example and not limitation, a stacked 16×16 matrix “C₁₆” denoted as “C_{16×16}” (which by virtue of its construction is its own inverse) may be used with, or in place of, a 256×256 matrix “C₂₅₆”, as will be described below.

The base Walsh-Hadamard matrix with dimensions of 2×2 may be represented as:

$${C}_{2} = [ \begin{matrix}1 & 1 \\ 1 & - 1\end{matrix} ] . \qquad ( 7 )$$

Thus, for example, in this instance of a code spreading factor of 2, a base station may use the codes of [1 1] and [1 −1] without interference between the two codes. Given the base vector C₂, a Walsh-Hadamard matrix with dimensions N×N, denoted as C_{N}, may be formed in two steps. The first step is the recursive construction of C_{N} from C_{N/2} matrices as follows:

$${C}_{N} = [ \begin{matrix}{C}_{N / 2} & {C}_{N / 2} \\ {C}_{N / 2} & - {C}_{N / 2}\end{matrix} ] . \qquad ( 8 )$$

The second step is to permute the columns of the matrix according to bit reversed addressing. In this way, vectors C of dimensions 16×16 (C₁₆) and 256×256 (C₂₅₆) may be constructed. Such matrices may be used to perform Fast Hadamard Transforms (FHT) on other vectors and/or matrices. Further details of FHT implementations are discussed in the sections and subsections that follow.

B. Example Mode for an Interfering Cell

In embodiments, symbol-level equalization may be performed between a serving cell operating in a standard mode and a non-serving, interfering cell. In embodiments, the serving cell operates using a first code spreading factor, and the non-serving cell operates using a second, different code spreading factor.

According to embodiments, obtaining the solution of Equation 2 using symbol-level equalization in the mode described in this subsection for both serving and non-serving cells may require that preprocessing be performed on, or adjustments be made to, the parameters therein. As described herein, a serving cell operating at SF256 and a non-serving cell operating at SF16 may be utilized. To accommodate asynchronous behaviors of non-serving and interfering cells, zero-padding of the channel response (vector H) and an offset of scrambling code indices (vector S) may be used to formulate the joint minimum mean square error (joint-MMSE) solution of both the serving cell and the interference cell according to embodiments.

For example, a preprocessing may be required due to differences of common pilot channel loading for a serving cell (\sqrt{E_{cS}}) and an interfering cell (\sqrt{E_{cI1}}). As such, if ρ₁=\sqrt{E_{cS}/E_{cI1}}, and the preprocessing compensates for the difference, then filtering coefficients for the interfering cell become:

h_{I1}→ρ₁h_{I1}, (9)

and this adjustment to the system equation may be represented as:

H=[H_{S}H_{I1}], (10)

where H_{S} (the serving cell channel vector) and H_{I1} (the non-serving, interfering cell channel vector) are zero-padded (Hs is zero-padding to the beginning, and H_{I1} is zero-padding to the end) to at most 24-tap to accommodate the interfering/asynchronous cell behavior.

The scrambling code vector matrix of each cell (Ss being the serving cell scrambling code vector, and S_{I1} being the non-serving, interfering cell scrambling code vector) does not need to be synchronized as the offset between these vectors is in multiples of 16-chips. Thus, this adjustment to the system equation may be represented as:

$$S = [ \begin{matrix}{S}_{S} & 0 \\ 0 & {S}_{I 1}\end{matrix} ] . \qquad ( 11 )$$

The OVSF code matrix of an interfering cell may be represented as a block diagonal matrix with a FHT16 as its diagonal values:

$${C}_{I 1} = [ \begin{matrix}{C}_{16} & 0 & 0 \\ 0 & ⋱ & 0 \\ 0 & 0 & {C}_{16}\end{matrix} ] , \qquad ( 12 )$$

and this adjustment to the system equation may be represented as:

$$C = [ \begin{matrix}{C}_{S} & 0 \\ 0 & {C}_{I 1}\end{matrix} ] , \qquad ( 13 )$$

where C_{S} is the serving cell OVSF vector, and C_{I1} is the non-serving, interfering cell OVSF vector. Additionally, a masking vector M (as described above) may be added to the system equation, where M may be represented as:

$$M = [ \begin{matrix}{M}_{S} & 0 \\ 0 & {M}_{I 1}\end{matrix} ] , \qquad ( 14 )$$

and where M_{S} is the serving cell masking vector, and M_{I1} is the non-serving, interfering cell masking vector.

These preprocessing and adjustment alterations to the system equation thus yield the right side of Equation 1 (i.e., equation element b) as:

b=M^{H}C^{H}S^{H}H^{H}y. (15)

It should be noted that in embodiments, for serving cells and/or interference cells, the per-code SNR may be overwritten by a predetermined or dynamically determined value (e.g., one value for serving cells and one value for each interfering cell. Such overwriting of the SNR values allows for an “identical independent distribution assumption” of interfering cells to be made, and thus the SyLK EQ method may behave like a chip equalization method when a highly dynamic system environment is observed.

Additionally, for serving cells, the OVSF matrix vector may be programmed to be the same matrix that is used in interfering cells.

C. Example Mode for Diversity with an Interfering Cell

In embodiments, symbol-level equalization may be performed between a serving cell operating in a diversity mode (e.g., a space time transmit diversity mode) and a non-serving, interfering cell. For example, the serving cell may operate using one source (e.g., a base station or the like in the serving cell) with multiple transmit antennas to provide information to a communication device. In embodiments, the serving cell operates using a first code spreading factor, and the non-serving cell operates using a second, different code spreading factor.

According to embodiments, obtaining the solution of Equation 2 using symbol-level equalization in the mode described in this subsection for both serving and non-serving cells may require that preprocessing be performed on, or adjustments be made to, the parameters therein. As described herein, a serving cell operating at SF256 and a non-serving cell operating at SF16 may be utilized. To accommodate asynchronous behaviors of non-serving and interfering cells, zero-padding of the channel response (vector H) and an offset of scrambling code indices (vector 5) may be used to formulate the joint minimum mean square error (joint-MMSE) solution of both the serving cell and the interference cell according to embodiments.

For example, preprocessing may be required for the currently described mode due to differences in noise observations n₀ and n₁ between the two respective antennas used in diversity mode and also due to differences of common pilot channel loading for a serving cell (\sqrt{E_{cS}}) and an interfering cell (\sqrt{E_{cI1}}). As such, if γ=\sqrt{n₀/n₁}, and if ρ₁=\sqrt{E_{cS}/E_{cI1}}, and the preprocessing compensates for these differences, then:

y_{A1}→γy_{A1}, (16)

and the filtering coefficients become:

h_{A1-S}→γh_{A1-S}, (17)

h_{A0-I1}→ρ₁h_{A0-I1}, (18)

and

h_{A1-I1}→γρ₁h_{A1-I1}, (19)

where A1 denotes antenna ‘1’, A1-S denotes antenna ‘1’ with respect to the serving cell, A0-I1 denotes antenna ‘0’ with respect to the interfering cell, and A1-I1 denotes antenna ‘1’ with respect to the interfering cell. These adjustments to the system equation may be represented as:

$$\begin{matrix}y = [ \begin{matrix}{y}_{A 0} \\ {y}_{A 1}\end{matrix} ] , \\ and & ( 20 ) \\ H = [ \begin{matrix}{H}_{A 0 - S} & {H}_{A 0 - I 1} \\ {H}_{A 1 - S} & {H}_{A 1 - I 1}\end{matrix} ] . & ( 21 )\end{matrix}$$

The scrambling code vector matrix of each cell (S_{S} being the serving cell scrambling code vector, and S_{I1} being the non-serving, interfering cell scrambling code vector) does not need to be synchronized because the offset between respective vectors is a multiple of 16-chips. Thus, this adjustment to the system equation is consistent with Equation 11 and may be represented as:

$$S = [ \begin{matrix}{S}_{S} & 0 \\ 0 & {S}_{I 1}\end{matrix} ] . \qquad ( 11 )$$

The OVSF code matrix of an interfering cell may be represented as a block diagonal matrix with a FHT16 as its diagonal values as in Equation 12:

$${C}_{I 1} = [ \begin{matrix}{C}_{16} & 0 & 0 \\ 0 & ⋱ & 0 \\ 0 & 0 & {C}_{16}\end{matrix} ] , \qquad ( 12 )$$

and this adjustment to the system equation may be represented as Equation 13:

$$C = [ \begin{matrix}{C}_{S} & 0 \\ 0 & {C}_{I 1}\end{matrix} ] , \qquad ( 13 )$$

where C_{S} is the serving cell OVSF vector, and C_{I1} is the non-serving, interfering cell OVSF vector. Additionally, a masking vector M (as described above) may be added to the system equation, where M may be represented as:

$$M = [ \begin{matrix}{M}_{S} & 0 \\ 0 & {M}_{I 1}\end{matrix} ] , \qquad ( 14 )$$

and where M_{S} is the serving cell masking vector, and M_{I1} is the non-serving, interfering cell masking vector.

These preprocessing and adjustment alterations to the system equation thus yield the right side of Equation 1 (i.e., equation element b) as:

b=M^{H}C^{H}S^{H}H^{H}y. (22)

Additionally, for serving cells, in accordance with this subsection, the OVSF matrix vector may be programmed to be the same matrix that is used in interfering cells.

D. Example Mode for Diversity with Multiple Interfering Cells

In embodiments, symbol-level equalization may be performed between a serving cell operating in a diversity mode (e.g., a space time transmit diversity mode) and two or more non-serving, interfering cells. For example, the serving cell may operate using one source (e.g., a base station or the like in the serving cell) with multiple transmit antennas to provide information to a communication device while the communication device receives information from two or more non-serving cells. In embodiments, the serving cell operates using a first code spreading factor, and the non-serving cells operate using a second, different code spreading factor.

According to embodiments, obtaining the solution of Equation 2 using symbol-level equalization in the mode described in this subsection for both serving and non-serving cells may require that preprocessing be performed on, or adjustments be made to, the parameters therein. As described herein, a serving cell operating at SF256 and two or more non-serving cells operating at SF16 may be utilized. To accommodate asynchronous behaviors of non-serving and interfering cells, zero-padding of the channel response (vector H) and an offset of scrambling code indices (vector S) may be used to formulate the joint minimum mean square error (joint-MMSE) solution of the serving cell and the interference cells according to embodiments.

For example, a preprocessing may be required for the currently described mode due to differences in noise observations n₀ and n₁ between the two respective antennas used in diversity mode and also due to differences of common pilot channel loading for a serving cell (\sqrt{E_{cS}}), a first interfering cell (\sqrt{E_{cI1}}), and a second interfering cell (\sqrt{E_{cI2}}). As such, if γ=\sqrt{n₀/n₁}, if ρ₁=\sqrt{E_{cS}/E_{cI1}}, and if ρ₂=\sqrt{E_{cS}/E_{cI2}}, and the preprocessing compensates for these differences, then:

y_{A1}→γy_{A1}, (16)

and the filtering coefficients become:

h_{A1-S}→γh_{A1-S}, (17)

h_{A0-I1}→ρ₁h_{A0-I1}, (18)

h_{A1-I1}→γρ₁h_{A1-I1}, (19)

h_{A0-I2}→ρ₂h_{A0-I2}, (23)

and

h_{A1-I2}→γρ₂h_{A1-I2}, (24)

where A1 denotes antenna ‘1’, A1-S denotes antenna ‘1’ with respect to the serving cell, A0-I1 denotes antenna ‘0’ with respect to the first interfering cell, A1-I1 denotes antenna ‘1’ with respect to the first interfering cell, A0-I1 denotes antenna ‘0’ with respect to the second interfering cell, and A1-I1 denotes antenna ‘1’ with respect to the second interfering cell. These adjustments to the system equation may be represented as:

$$\begin{matrix}y = [ \begin{matrix}{y}_{A 0} \\ {y}_{A 1}\end{matrix} ] , \\ and & ( 20 ) \\ H = [ \begin{matrix}{H}_{A 0 - S} & {H}_{A 0 - I 1} & {H}_{A 0 - I 2} \\ {H}_{A 1 - S} & {H}_{A 1 - I 2} & {H}_{A 1 - I 2}\end{matrix} ] . & ( 25 )\end{matrix}$$

The scrambling code vector matrix of each cell (S_{S} being the serving cell scrambling code vector, S_{I1} being the first non-serving, interfering cell scrambling code vector, and S_{I2} being the second non-serving, interfering cell scrambling code vector) does not need to be synchronized because each offset between respective vectors is a multiple of 16-chips. Thus, this adjustment to the system equation may be represented as:

$$S = [ \begin{matrix}{S}_{s} & 0 & 0 \\ 0 & {S}_{I 1} & 0 \\ 0 & 0 & {S}_{I 2}\end{matrix} ] . \qquad ( 26 )$$

The OVSF code matrix of the interfering cells may be represented as a block diagonal matrix with a FHT16 as its diagonal values as in Equation 12:

$${C}_{I 1} = {C}_{I 2} = [ \begin{matrix}{C}_{16} & 0 & 0 \\ 0 & ⋱ & 0 \\ 0 & 0 & {C}_{16}\end{matrix} ] , \qquad ( 27 )$$

and this adjustment to the system equation may be represented as:

$$C = [ \begin{matrix}{C}_{s} & 0 & 0 \\ 0 & {C}_{I 1} & 0 \\ 0 & 0 & {C}_{I 2}\end{matrix} ] , \qquad ( 28 )$$

where C_{S} is the serving cell OVSF vector, and C_{I1} is the non-serving, interfering cell OVSF vector. Additionally, a masking vector M (as described above) may be added to the system equation, where M may be represented as:

$$M = [ \begin{matrix}{M}_{s} & 0 & 0 \\ 0 & {M}_{I 1} & 0 \\ 0 & 0 & {M}_{I 2}\end{matrix} ] , \qquad ( 29 )$$

and where M_{S} is the serving cell masking vector, M_{I1} is the first non-serving, interfering cell masking vector, and M_{I2} is the second non-serving, interfering cell masking vector.

These preprocessing and adjustment alterations to the system equation thus yield the right side of Equation 1 (i.e., equation element b) as:

b=M^{H}C^{H}S^{H}H^{H}y. (30)

Additionally, for serving cells, in accordance with this subsection, the OVSF matrix vector may be programmed to be the same matrix that is used in interfering cells.

E. Further Example Modes

It is contemplated that a communication device, a receiver, and/or an equalizer as described herein may also operate in additional modes with or without the preprocessing and/or adjustments described in preceding sections and subsections. For instance, an “oversampling by 2” mode, a diversity mode with no interference cell modeling, and/or a basic mode with no oversampling equalizer, no diversity, and no interfering cell modeling may be operated in by a communication device, a receiver, and/or an equalizer as described herein in various embodiments.

F. Example Boundary Condition Embodiments

In embodiments, equalizers described herein (e.g., EQ 332 and/or SyLK EQ) may operate as block equalizers, and thus inter-block interference (IBI) due to multipath fading may be addressed to improve performance. To alleviate and/or eliminate the IBI effect, an “overlap-and-cut” approach may be utilized. The overlap length (denoted herein as “overlapLength”) may be a programmable value suitable for FHT operation and may initially operate at a default value (e.g., set to 32). In overlap operation, an equalizer functioning as a block equalizer may operate on a number of samples equal to 256+2*overlapLength. In operation, the middle 256 output values may be considered for further processing and/or equalization. For example, a padded scrambling code matrix of a given serving cell having padding on each side of the original matrix may be represented as:

$${S}_{s} = [ \begin{matrix}{S}_{S}^{-} & 0 & 0 \\ 0 & {S}_{s} & 0 \\ 0 & 0 & {S}_{S}^{+}\end{matrix} ] , \qquad ( 31 )$$

where S_{S}⁻ and S_{S}⁺ represent diagonal matrices with diagonal elements being scrambling sequences of previous chips (where the number of previous chips is equal to overlapLength) and being scrambling sequences of the next chips (where the number of the next chips is equal to overlapLength), respectively, of the current desired 256 chips.

The OVSF code matrix of the given serving cell having padding on each side of the original matrix may be represented as:

$${C}_{s} = [ \begin{matrix}{C}_{overlapLength} & 0 & 0 \\ 0 & {C}_{s} & 0 \\ 0 & 0 & {C}_{overlapLength}\end{matrix} ] , \qquad ( 32 )$$

and the OVSF code matrix of a corresponding interfering cell (having padding on each side) will be extended by multiple of C₁₆, for example, if overlapLength is set to its default 32:

$$\begin{matrix}{C}_{I 1} = [ \begin{matrix}{C}_{2 \times 16} & 0 & 0 \\ 0 & {C}_{I 1} & 0 \\ 0 & 0 & {C}_{2 \times 16}\end{matrix} ] , \\ where & ( 33 ) \\ {C}_{2 \times 16} = [ \begin{matrix}{C}_{16} & 0 \\ 0 & {C}_{16}\end{matrix} ] . & ( 34 )\end{matrix}$$

The channel matrix H (having padding on each side) may be represented as an expansion of the Toeplitz-style matrix formulated by a channel delay profile as described above in §6.A.

The next section describes example operational embodiments for symbol-level equalization for serving and non-serving cells.

### 7. Example Operational Embodiments

The embodiments described herein may perform their functions in various ways. For example, FIG. 6 shows a flowchart 600 providing example steps for performing symbol-level equalization on serving and non-serving cell data communications, according to an exemplary embodiment. Communication device 200 of FIG. 2, receiver 300 and EQ 332 of FIG. 3 and computer 800 of FIG. 8 (described below) may each operate according to flowchart 600, in an embodiment. Other structural and operational embodiments will be apparent to persons skilled in the relevant art(s) based on the discussion regarding flowchart 600. Flowchart 600 is described as follows.

Flowchart 600 begins with step 602. In step 602, first data communications are received from a serving cell that operates using a first spreading factor. The serving cell may be operating in SF256, though the scope of the example embodiments is not limited in this respect. For instance, the serving cell may operate in accordance with any suitable spreading factor domain. The first data communications may include voice and/or data transmissions and may be transmitted from a base station or the like in the serving cell.

In step 604, second data communications are received from at least one non-serving cell that operates using a second spreading factor that is different from the first spreading factor. The at least one non-serving cell may be operating in SF16, though the scope of the example embodiments is not limited in this respect. For instance, the at least one non-serving cell may operate in accordance with any suitable spreading factor domain. The second data communications may include voice and/or data transmissions and may be transmitted from at least one base station or the like in the respective at least one non-serving cell.

In step 606, symbol-level equalization is performed on a first plurality of data communications that includes the first data communications and the second data communications. For example, an equalizer (e.g., EQ 332 of FIG. 3) may perform the symbol-level equalization on the first plurality of data communications in accordance with the embodiments and/or Equations described herein.

It is also contemplated that, while flowchart 600 (and in particular step 606) is described in terms of performing symbol-level equalization, the performance of such equalization may comprise an iterative process as described in various embodiments herein.

In some example embodiments, one or more steps 602, 604, and/or 606 of flowchart 600 may not be performed. Moreover, steps in addition to or in lieu of steps 602, 604, and/or 606 may be performed. Further, in some example embodiments, one or more of steps 602, 604, and/or 606 may be performed out of order, in an alternate sequence, or partially, substantially, or completely concurrently with other steps.

As noted above with respect to FIG. 6, the embodiments described herein may perform their functions in various ways. For example, FIG. 7 shows a flowchart 700 providing example steps for performing symbol-level equalization on serving and non-serving cell data communications, according to an exemplary embodiment. In some embodiments, flowchart 700 may be a further embodiment of flowchart 600, as shown in FIG. 6. Communication device 200 of FIG. 2, receiver 300 and EQ 332 of FIG. 3, and computer 800 of FIG. 8 (described below) may each operate according to flowchart 700, in an embodiment. Other structural and operational embodiments will be apparent to persons skilled in the relevant art(s) based on the discussion regarding flowchart 700. Flowchart 700 is described as follows.

Flowchart 700 begins with step 702. In step 702, first data communications are received from a serving cell that operates using a first spreading factor. The serving cell may be operating in SF256, though the scope of the example embodiments is not limited in this respect. For instance, the serving cell may operate in accordance with any suitable spreading factor domain. The first data communications may include voice and/or data transmissions and may be transmitted from a base station or the like in the serving cell.

In step 704, second data communications are received from at least one non-serving cell that operates using a second spreading factor that is different from the first spreading factor. The at least one non-serving cell may be operating in SF16, though the scope of the example embodiments is not limited in this respect. For instance, the at least one non-serving cell may operate in accordance with any suitable spreading factor domain. The second data communications may include voice and/or data transmissions and may be transmitted from at least one base station or the like in the respective at least one non-serving cell.

In step 706, third data communications are received from one or more additional non-serving cells that operate using the second spreading factor. The one or more additional non-serving cells may be operating in SF16, though the scope of the example embodiments is not limited in this respect. For instance, the one or more additional non-serving cells may operate in accordance with any suitable spreading factor domain. The third data communications may include voice and/or data transmissions and may be transmitted from one or more base stations or the like in the one or more respective additional non-serving cells.

In step 708, a first plurality of data communications that includes the first data communications and the second data communications is aligned using an extended channel representation of the at least one non-serving cell. In embodiments, the alignment of the data communications may be performed by an adjustment block (e.g., adjustment block 326 of FIG. 3) and/or by an equalizer (e.g., EQ 332 of FIG. 3). The alignment may include extending channel representations of one or more of the data communications in the first plurality of data communications. The alignment may include using scrambling code offsets associated with one or more of the data communications in the first plurality of data communications.

In step 710, symbol-level equalization is performed on the first plurality of data communications. For example, an equalizer (e.g., EQ 332 of FIG. 3) may perform the symbol-level equalization on the first plurality of data communications in accordance with the embodiments and/or Equations described herein.

In step 712, a second plurality of data communications that includes the first data communications and the third data communications is aligned using an extended channel representation of the one or more additional non-serving cells. In embodiments, the alignment of the data communications may be performed by an adjustment block (e.g., adjustment block 326 of FIG. 3) and/or by an equalizer (e.g., EQ 332 of FIG. 3). The alignment may include extending channel representations of one or more of the data communications in the second plurality of data communications. The alignment may include using scrambling code offsets associated with one or more of the data communications in the second plurality of data communications.

In step 714, symbol-level equalization is performed on the second plurality of data communications. For example, an equalizer (e.g., EQ 332 of FIG. 3) may perform the symbol-level equalization on the second plurality of data communications in accordance with the embodiments and/or Equations described herein.

It is also contemplated that, while flowchart 700 (and in particular steps 710 and 716) is described in terms of performing symbol-level equalization, the performance of such equalization may comprise an iterative process as described in various embodiments herein.

In some example embodiments, one or more steps 702, 704, 706, 708, 710, 712, and/or 714 of flowchart 700 may not be performed. Moreover, steps in addition to or in lieu of steps 702, 704, 706, 708, 710, 712, and/or 714 may be performed. Further, in some example embodiments, one or more of steps 702, 704, 706, 708, 710, 712, and/or 714 may be performed out of order, in an alternate sequence, or partially (or completely) concurrently with other steps.

The next section describes further example embodiments and advantages of symbol-level equalization for serving and non-serving cells.

### 8. Further Example Embodiments and Advantages

The embodiments described herein enable symbol-level equalization between serving cells and non-serving cells (interfering and/or asynchronous cells). While embodiments may be described in the context of telecommunication systems, it is contemplated that the symbol-level equalization embodiments described herein may be applicable to equalization strategies and implementations other than those explicitly set forth herein. For example, the techniques described herein may generally be applicable to equalization between synchronous and asynchronous sources. Similarly, practice of the techniques described herein is not specifically limited to WCDMA and HSDPA, but may also provide improved equalization, for example and without limitation, to non-serving cells dominated by High Speed Downlink Shared Channel (“HS-DSCH”) usage. Likewise, spreading factors other than those illustrated herein (i.e., SF256 for serving cells and SF16 for non-serving cells) may be used to improve symbol-level equalization in accordance with the embodiments described herein.

An additional advantage of the techniques disclosed is that system performance for non-serving cells (e.g., asynchronous and interfering cells) transmitting to communication devices using symbol-level equalization may be comparable to serving cells operating synchronously without adding substantial complexity and/or overhead. Further advantages are realized in that symbol-level equalization outperforms chip-level equalization, and, in accordance with the described techniques, non-serving cells may efficiently and correctly perform symbol-level equalization while maintaining joint-MMSE with serving cells.

It will be recognized that the systems, their respective components, and/or the techniques described herein may be implemented in hardware (e.g., electrical circuitry), software, firmware, or any combination thereof. The disclosed technologies can be put into practice using software, firmware, and/or hardware implementations other than those described herein. Any software, firmware, and hardware implementations suitable for performing the functions described herein can be used, such as those described herein.

Example computer embodiments are described in the next section.

### 9. Example Computer Embodiments

Communication device 116, communication device 200, receiver 202, receiver block 208, adjustment block 212, equalizer block 216, receiver 300, baseband radio frequency sampler (BBRF) 302, decimator 306, memory buffer 310, common pilot channel processing block (CPICH) 312, delay locked loop (DLL) 316, channel estimation block (ChEst) 322, adjustment block 326, equalizer (EQ) 332, flowcharts 600 and 700, and/or any further systems, sub-systems, and/or components disclosed herein may be implemented in hardware (e.g., hardware logic/electrical circuitry), or any combination of hardware with software (computer program code configured to be executed in one or more processors or processing devices) and/or firmware.

The embodiments described herein, including systems, methods/processes, and/or apparatuses, may be implemented using well known processing devices, telephones (smart phones and/or mobile phones), servers, and/or computers, such as a computer 800 shown in FIG. 8. It should be noted that computer 800 may represent communication devices, processing devices, and/or traditional computers in one or more embodiments. For example, communication device 116, communication device 200, receiver 300, equalizer (EQ) 332, and any of the sub-systems or components respectively contained therein may be implemented using one or more computers 800.

Computer 800 can be any commercially available and well known communication device, processing device, and/or computer capable of performing the functions described herein, such as devices/computers available from International Business Machines®, Apple®, Sun®, HP®, Dell®, Cray®, Samsung®, Nokia®, etc. Computer 800 may be any type of computer, including a desktop computer, a server, etc.

Computer 800 includes one or more processors (also called central processing units, or CPUs), such as a processor 806. Processor 806 is connected to a communication infrastructure 802, such as a communication bus. In some embodiments, processor 806 can simultaneously operate multiple computing threads.

Computer 800 also includes a primary or main memory 808, such as random access memory (RAM). Main memory 808 has stored therein control logic 824 (computer software), and data.

Computer 800 also includes one or more secondary storage devices 810. Secondary storage devices 810 include, for example, a hard disk drive 812 and/or a removable storage device or drive 814, as well as other types of storage devices, such as memory cards and memory sticks. For instance, computer 800 may include an industry standard interface, such a universal serial bus (USB) interface for interfacing with devices such as a memory stick. Removable storage drive 814 represents a floppy disk drive, a magnetic tape drive, a compact disk drive, an optical storage device, tape backup, etc.

Removable storage drive 814 interacts with a removable storage unit 816. Removable storage unit 816 includes a computer useable or readable storage medium 818 having stored therein computer software 826 (control logic) and/or data. Removable storage unit 816 represents a floppy disk, magnetic tape, compact disk, DVD, optical storage disk, or any other computer data storage device. Removable storage drive 814 reads from and/or writes to removable storage unit 816 in a well-known manner.

Computer 800 also includes input/output/display devices 804, such as touchscreens, LED and LCD displays, monitors, keyboards, pointing devices, etc.

Computer 800 further includes a communication or network interface 818. Communication interface 820 enables computer 800 to communicate with remote devices. For example, communication interface 820 allows computer 800 to communicate over communication networks or mediums 822 (representing a form of a computer useable or readable medium), such as LANs, WANs, the Internet, etc. Network interface 820 may interface with remote sites or networks via wired or wireless connections.

Control logic 828 may be transmitted to and from computer 800 via the communication medium 822.

Any apparatus or manufacture comprising a computer useable or readable medium having control logic (software) stored therein is referred to herein as a computer program product or program storage device. This includes, but is not limited to, computer 800, main memory 808, secondary storage devices 810, and removable storage unit 816. Such computer program products, having control logic stored therein that, when executed by one or more data processing devices, cause such data processing devices to operate as described herein, represent embodiments of the disclosed technologies.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic to implement, for example, communication device 116, communication device 200, receiver 202, receiver block 208, adjustment block 212, equalizer block 216, receiver 300, baseband radio frequency sampler (BBRF) 302, decimator 306, memory buffer 310, common pilot channel processing block (CPICH) 312, delay locked loop (DLL) 316, channel estimation block (ChEst) 322, adjustment block 326, equalizer (EQ) 332, flowcharts 600 and 700, their respective systems, sub-systems, and/or components, and/or further embodiments described herein. Embodiments of the disclosed technologies are directed to computer program products comprising such logic (e.g., in the form of program code, instructions, or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

### 10. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method, comprising:
receiving first data communications from a serving cell that operates using a first spreading factor;
receiving second data communications from at least one non-serving cell that operates using a second spreading factor that is different from the first spreading factor; and
performing symbol-level equalization on a first plurality of data communications that includes the first data communications and the second data communications.

2. The method of claim 1, wherein the first spreading factor is a 256-code spreading factor; and
wherein the second spreading factor is a 16-code spreading factor.

3. The method of claim 2, wherein each code of the 256-code spreading factor and each code of the 16-code spreading factor corresponds to a respective symbol.

4. The method of claim 1, further comprising:
aligning the first plurality of data communications using an extended channel representation of the at least one non-serving cell.

5. The method of claim 4, wherein the extended channel representation includes a scrambling code offset.

6. The method of claim 4, further comprising:
receiving third data communications from one or more additional non-serving cells that operate using the second spreading factor; and
aligning a second plurality of data communications that includes the first data communications and the third data communications using an extended channel representation of the one or more additional non-serving cells;
wherein performing the symbol-level equalization comprises:
performing the symbol-level equalization on the second plurality of data communications in response to aligning the second plurality of data communications.

7. The method of claim 1, wherein performing the symbol-level equalization comprises:
performing an iterative linear equation calculation to obtain a joint linear minimum mean square error between the serving cell and the at least one non-serving cell.

8. The method of claim 1, wherein performing the symbol-level equalization comprises:
performing the symbol-level equalization at a mobile communication device.

9. The method of claim 1, wherein the non-serving cell is an asynchronous interfering cell.

10. A mobile communication device, comprising:
a receiver block configured to receive first data communications from a serving cell that operates using a first spreading factor and second data communications from at least one non-serving cell that operates using a second spreading factor that is different from the first spreading factor;
an adjustment block configured to align the first data communications and the second data communications with respect to time to provide aligned first and second data communications; and
an equalizer block configured to perform symbol-level equalization on the aligned first and second data communications.

11. The mobile communication device of claim 10, wherein the first spreading factor is a 256-code spreading factor and the second spreading factor is a 16-code spreading factor.

12. The mobile communication device of claim 11, wherein the adjustment block is configured to align the first data communications and the second data communications using at least one extended channel representation of the at least one respective non-serving cell.

13. The mobile communication device of claim 12, wherein the at least one extended channel representation includes a scrambling code offset.

14. The mobile communication device of claim 10, wherein the equalizer block is configured to perform the symbol-level equalization by performing an iterative linear equation calculation to obtain a joint linear minimum mean square error between the serving cell and the at least one non-serving cell.

15. The mobile communication device of claim 10, wherein the at least one non-serving cell includes a plurality of non-serving cells that operate using the second spreading factor.

16. The mobile communication device of claim 10, wherein the at least one non-serving cell is at least one respective asynchronous interfering cell.

17. A computer-readable storage medium having computer program instructions recorded thereon that, when executed, enable a processor-based system to perform a method, the method comprising:
receiving first data communications from a serving cell that operates using a first spreading factor;
receiving second data communications from at least one non-serving cell that operates using a second spreading factor that is different from the first spreading factor; and
performing symbol-level equalization on a plurality of data communications that includes the first data communications and the second data communications.

18. The computer-readable storage medium of claim 17, wherein the first spreading factor is a 256-code spreading factor, and wherein the second spreading factor is a 16-code spreading factor, and
wherein each code of the 256-code spreading factor and each code of the 16-code spreading factor corresponds to a respective symbol.

19. The computer-readable storage medium of claim 17, further comprising:
aligning the plurality of data communications using at least one extended channel representation of the at least one respective non-serving cell, wherein the at least one extended channel representation includes a scrambling code offset.

20. The computer-readable storage medium of claim 17, wherein at least one of:
performing the symbol-level equalization comprises performing an iterative linear equation calculation to obtain a joint linear minimum mean square error between the serving cell and the at least one non-serving cell, or
the at least one non-serving cell is at least one respective asynchronous interfering cell.
